(19) United States
(12) Patent Application Publication
(10) Pub. No.: US 2024/0154481 A1
(43) Pub. Date: May 9, 2024

(54) ROTOR FOR AN AXIAL FLUX ELECTRIC MACHINE, AND METHODS FOR ASSEMBLING AND REMOVING SUCH A ROTOR

(71) Applicants: RENAULT S.A.S., Boulogne Billancourt (FR); WHYLOT, Cambes (FR)

(72) Inventors: Patrice DUHAUT, St Pierre d'Autils (FR); Loic MAYEUR, St Santin (FR)

(21) Appl. No.: 18/548,829

(22) PCT Filed: Mar. 22, 2022
(86) PCT No.: PCT/EP2022/057539

§ 371 Date: Sep. 1, 2023

(30) Foreign Application Priority Data
Mar. 24, 2021 (FR) FR2102964

(51) Int. Cl. H02K 1/28; H02K 1/2795; H02K 15/00; H02K 15/03; H02K 21/24

(52) U.S. Cl. CPC H02K 1/28; H02K 1/2795; H02K 15/0006; H02K 15/03; H02K 21/24

(57) ABSTRACT

Disclosed is a rotor including: a body including a hub from which a plurality of arms extend; a plurality of magnet blocks disposed between the arms; and a circular ring disposed at the periphery of the rotor. One of an inner face of the circular ring and an outer face of each of the magnet blocks has a first depression, the other having a complementary shape. The rotor includes a plurality of holders each arranged between the body and a magnet block so as to urge the magnet block against the circular ring with the circular ring and the magnet block nested at the first depression.

### CROSS-REFERENCE TO RELATED APPLICATIONS

This application is the US national stage of PCT/EP2022/057539, filed Mar. 22, 2022 and designating the United States, which claims the priority of FR FR2102964, filed Mar. 24, 2021. The entire contents of each foregoing application are incorporated herein by reference.

### BACKGROUND OF THE INVENTION

### Field of the Invention

The present invention generally relates to the field of axial flux electric machines.

It relates more specifically to a rotor for an axial flux electric machine, said rotor having a disc shape centered about a longitudinal axis and comprising:
a body comprising a hub from which a plurality of arms extend;
a plurality of magnet blocks, each magnet block being disposed between two adjacent arms;
a circular ring disposed at the periphery of the rotor and surrounding the magnet blocks.

The invention has a particularly advantageous application in electric engines for electric or hybrid motor vehicles.

It also relates to methods for assembling and removing such a rotor.

### Description of the Related Art

An axial flux electric machine generally comprises two stators and one rotor, air gaps separating these two types of elements. The rotor carries a series of permanent magnets or magnet blocks, while a series of coils is carried by the stators.

When the coils are powered by an electric current, the rotor, which is secured to the output shaft of the engine, is subjected to a torque resulting from the magnetic field (the magnetic flux created being an axial flux for an axial flux electric machine).

Conventionally, to assemble such a rotor, on the one hand, a body is manufactured in disc shape and having notches, and on the other hand, the magnet blocks. The magnet blocks are then implemented in the notches provided for this purpose.

To secure the magnet blocks to the body, they are conventionally adhered to the latter. Using adhesive however has several disadvantages.

First, the adhesives used are thermosetting adhesives. Once injected, the rotor must thus be heated at a very high temperature in a furnace and subjected to a holding pressure, which represents both a certain material and energy cost. The series manufacture of adhesive-based rotors is therefore expensive.

Furthermore, an adhesive layer adds an additional link in the chain of dimensions, which complexifies the design of the rotor and does not guarantee the obtaining of an identical air gap difference (which necessarily has a damaging impact on the magnetic performance).

In addition, once adhered, the magnet blocks can no longer be disconnected from the body. The adhesion therefore limits the options for maintaining the rotor, a faulty magnet block not being able, for example, to be replaced by a new magnet block. With the adhesive not being recyclable, once adhered, the rotor or its elements are not either.

Adhesive-free rotors have been proposed, like for example in document FR3027468. In these rotors, the notches are radially open outwards, such that they do not surround the magnet blocks at the periphery of the rotor. The magnet blocks are secured to the body by the implementation, by force, of a pre-urged circular fret surrounding the assembly constituted of the body and of the magnet blocks.

The implementation of a fret is however complex as it requires a great accuracy both with the manufacturing of parts and the application of the force by a specific press to implement the fret. Like adhesive, this solution therefore remains difficult to industrialize.

In addition, once the fret is implemented, the rotor is not longer removable (or is very difficult to remove), which limits, once again, the options of maintaining or recycling parts.

### SUMMARY OF THE INVENTION

In this context, a rotor for an axial flux electric machine is proposed, such as defined in the introduction, wherein it is provided that one of an inner face of the circular ring and an outer face of each of the magnet blocks has a first depression, the other having a complementary shape; and wherein the rotor comprises a plurality of holding means, each arranged between the body and one of the magnet blocks so as to urge said magnet block against the circular ring with the circular ring and said magnet block nested at said first depression.

Thus, thanks to the invention, the rotor is assembled without adhesive nor fretting. The holding means, in engagement with the hollow circular ring, ensure the cohesion of the rotor.

Not fixing the magnet blocks to the body by adhering or by fretting makes it possible to do without specific machines, and thus reduce the manufacturing costs. This also simplifies the series manufacture of the rotor, by removing complex steps, such as heating at a high temperature or fretting.

Furthermore, the rotor according to the invention makes it possible to consider the separation of the magnet blocks from the body, and thus to facilitate the maintenance and the recycling of the rotor, or only some of its elements.

What is more, in a preferred embodiment, the magnet blocks can make small translations in radial directions. The holding means thus play the role of dampers when the magnet blocks move towards the center of the rotor. The urges that the magnet blocks undergo are thus reduced, which makes it possible to limit the risks of breaking and increase their longevity.

Other advantageous and non-limiting features of the rotor according to the invention, taken individually or according to all the technically possible combinations, are as follows:
said holding means are removable;
said circular ring is resilient;
each of said holding means is disposed in a housing provided in the body, said housing comprising an opening designed to introduce said holding means in said housing, said opening having a size less than that of said holding means;
said holding means are springs or clips or fretted pin gauges;
each of said holding means is surrounded between an inner face of a magnet block and the body;
each of said holding means is eccentric with respect to the thickness of the body about the longitudinal axis;
each of said arms comprises two second depressions or protrusions opposite one another and extending in length in an extension direction of said arm, and each of said magnet blocks has two side faces, each comprising a third depression or protrusion, of shape complementary to that of the second depression or protrusion of the arm with which said side face is in contact;
each of said second depressions or protrusions has a depth or respectively a height, towards the side face with which said second depression or protrusion is in contact, increasing by moving closer to the longitudinal axis;
each of said magnet blocks comprises a plurality of single magnets, glued or fretted in a peripheral support;
anti-vibration means are provided between each magnet block and the hub;
said body is made of aluminum.

The invention also proposes a method for assembling a rotor such as described above comprising the following steps:
insertion of the magnet blocks between the arms;
implementation of the circular ring around the magnet blocks;
activation of the holding means between the body and the magnet blocks so as to urge the magnet blocks against the circular ring.

This assembling method makes it possible to assemble the rotor without fretting nor adhering. Indeed, before the implementation of the holding means, the magnet blocks are slightly closer to the body, which leaves a sufficient clearance to implement the circular ring, without force.

The invention finally proposes a method for removing a rotor such as described above, comprising the following steps:
deactivation of the holding means so as to separate the magnet blocks from the circular ring;
removal of the circular ring from the periphery of the magnet blocks;
removal of at least one of the magnet blocks from between the arms.

This removal method makes it possible, for example, to be able to separate one of the elements of the rotor, with the aim of repairing it or replacing it. Generally, this removal method facilitates the maintenance of the rotor.

Naturally, the different features, variants and embodiments of the invention can be associated with one another according to various combinations, insofar as they are not incompatible or exclusive from one another.

### BRIEF DESCRIPTION OF THE DRAWINGS

The description below regarding the accompanying drawings, given as non-limiting examples, will make it understood what the invention consists of, and how it can be achieved.

In the accompanying drawings:

FIG. 1 is a schematic view of a rotor according to the invention;

FIG. 2 is a schematic, perspective view of a part of the body of the rotor of FIG. 1;

FIG. 3 is a schematic, perspective view of a magnet block of the rotor of FIG. 1;

FIG. 4 is a schematic, cross-sectional view along the plane A-A of a peripheral portion of the rotor of FIG. 1;

FIG. 5 is a schematic, cross-sectional view of a peripheral portion of a variant of an embodiment of a rotor according to the invention;

FIG. 6 is a schematic, perspective view of a holding means of the rotor of FIG. 1 before its implementation;

FIG. 7 is a schematic, perspective view of the holding means of FIG. 6 after its implementation;

FIG. 8 is a schematic, perspective view of a holding means of a variant of an embodiment of a rotor according to the invention.

### DETAILED DESCRIPTION

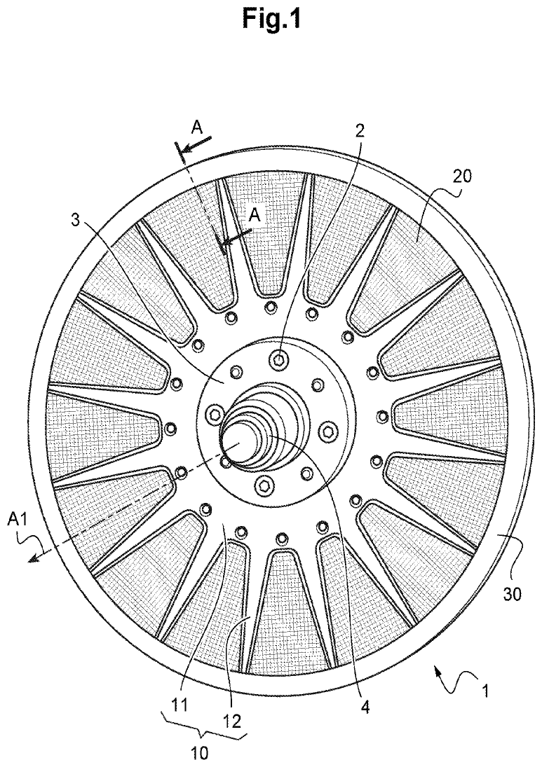

A rotor for an axial flux electric machine according to the invention, such as represented in FIG. 1 and referenced in its entirety by the reference 1, mainly has a disc shape centered about a longitudinal axis A1. In this case, the rotor 1 has, more specifically, a flattened cylinder shape, the thickness of which, dimension about the longitudinal axis 1, is a lot less than the diameter, dimension along a radial direction, perpendicular to the longitudinal axis A1. The longitudinal axis A1 corresponds, in this case, to the axis of rotation of the rotor 1 when it rotates within an electric machine.

In FIG. 1, the rotor 1 is secured by screws 2 to a flange 3 and to an engine shaft 4. The rotor 1 is, for example, comprised between two disc-shaped stators, also centered about the longitudinal axis A1. When the stators rotate the rotor 1, the latter drives the engine shaft 4. The electric machine comprising the rotor 1 and the stators thus produces a torque.

The rotor 1 has two opposite circular faces. The distance between these two circular faces about the longitudinal axis A1 defines the thickness of the rotor 1. Below, the periphery of the rotor 1 is called its outer part, opposed to its central part, located at the longitudinal axis A1. Thus, the periphery of the rotor 1 corresponds to a circular perimeter located at a distance from the longitudinal axis A1.

As FIG. 1 shows, the rotor 1 comprises:
a body 10;
a plurality of magnet blocks 20 disposed at the periphery of the body 10;
a circular ring 30 surrounding the magnet blocks 20, the circular ring 30 and the magnet blocks 20 being nested at a first depression 50 (which cannot be seen in FIG. 1);
a plurality of holding means 40 of the magnet blocks 20 (which cannot be seen in FIG. 1).

The body 10 comprises a hub 11 and a plurality of arms 12 extending from the hub 11. The hub 11 constitutes the central part of the body 10 and has a central recessing enabling the fixing of the flange 3 and of the engine shaft 4. In this case, the arms 12 extend in directions substantially radial with respect to the longitudinal axis A1. Such as represented in the figures, the arms 12 taper towards the periphery of the rotor 1.

The arms 12 are all identical and regularly distributed around the hub 11, so as to be separated, two-by-two, by a space.

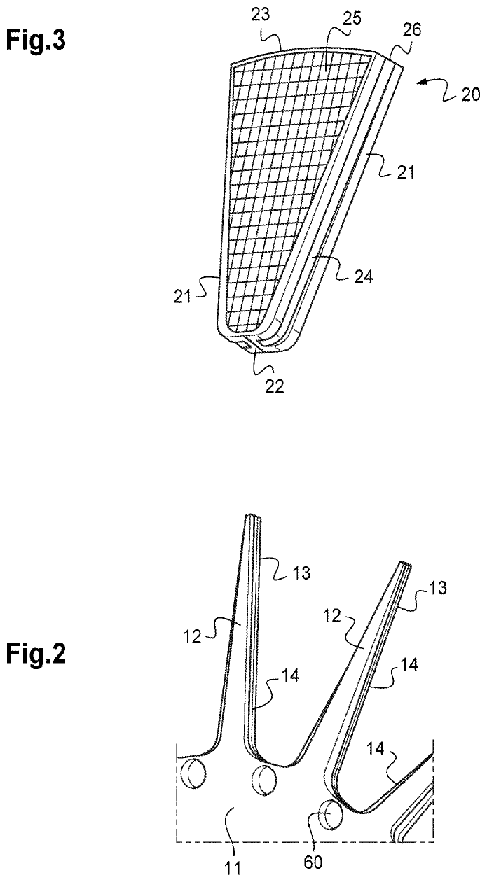

As appears in FIG. 2, each pair of two adjacent arms 12 delimits a trapezoidal-shaped notch 13. Two arms 12 are, in this case, adjacent when they are not separated by another arm. The notch 13 is, in this case, radially open towards the periphery of the rotor 1.

In this case, the body 10 is preferably made of aluminum, which makes it possible to reduce the manufacturing costs of the rotor 1. As is described below, the use of an aluminum body 1, more fragile than a body made of composite material, is made possible by the fact that the magnet blocks 20 are not fixed to the arms 12. The arms 12 thus undergo almost no radial urges when the rotor 1 is in operation.

The body 10 is, for example, made by a stack of aluminum sheets of a thickness less than or equal to one millimeter. In a variant, it can be provided that the body 10 of the rotor 1 is made of another metal material or of composite materials, for example, fiber compounds buried in a resin.

The magnet blocks 20 are distributed in free spaces between the arms 12.

Each magnet block 20 is disposed between two adjacent arms 12. Each magnet block 20 is thus disposed in a notch 13, the shape of the notches being adapted to the shape of the magnet blocks 20. One single magnet block 20 is disposed between each pair of adjacent arms 12. The rotor 1 therefore comprises as many magnet blocks 20 as arms 12, for example 16 of each, like in the example illustrated in FIG. 1.

As FIG. 3 more specifically shows, each magnet block 20 has, in this case, a mainly trapezoidal shape. Each magnet block 20 thus comprises two main faces of substantially trapezoidal shapes and two side faces 21. Within the rotor 1, each side face 21 faces an arm 12. Each magnet block 20 also comprises an inner face 22, facing, within the rotor 1, the hub 11. Finally, each magnet block 20 comprises an outer face 23. The outer face 23 is located at the periphery of the rotor 1 and mainly has a circular arc-shaped curvature.

In this case, as FIG. 3 more specifically shows, each magnet block 20 comprises a plurality of single magnets 25 inserted inside a peripheral support 26. The single magnets 25 are, for example, adhered or fretted in the peripheral support 26. In this case, the side 21, inner 22 and outer 23 faces of the magnet blocks 20 are formed by the peripheral support 26. The peripheral support 26 is made of an antimagnetic material, for example made of polymer.

To ensure the holding of the magnet blocks 20 in the body 10 about the longitudinal axis A1, each magnet block 20 is sandwiched between two adjacent arms 12 by means of slider connections, in this case, of the groove-rib type, extending towards the periphery of the rotor 1.

To make slider connections, each arm 12 comprises two second depressions or protrusions 14, opposite one another and extending in length in an extension direction of the arm 12, i.e. towards the periphery of the rotor 1. Each magnet block 20 itself comprises, at each of its side faces 21, a third depression or protrusion 24 of shape complementary to the second depression or protrusion 14. The third depressions or protrusions 24 are, in this case, formed in the peripheral support 26.

In this case, for each arm 12, the second depressions or protrusions 14 are of the same type.

In practice, as FIG. 2 shows, each arm 12 carries on its two opposite sides (those located facing the magnet blocks 20), two ribs, the profiles of which have rectangular sections (these ribs form the two second depressions or protrusions 14). Correspondingly, as FIG. 3 shows, the two side faces 21 of each magnet block 20 each have a hollow groove designed to be inserted in the rib of the corresponding arm 12. In a variant, the arms 12 could comprise grooves and the magnet blocks 20 could comprise ribs.

Advantageously, providing ribs on the arms 12 and grooves on the magnet blocks 20 makes it possible to reinforce the arms 12.

As FIGS. 2 and 3 show, the dimension of the second depressions or protrusions 14 and of the third depressions or protrusions 24 in a plane orthogonal to the longitudinal axis A1, i.e. in this case, the depth of the ribs and the height of the grooves along the orthoradial dimension of the rotor, progressively increases by moving closer to the longitudinal axis A1. This variation of size of the nesting makes it possible to improve the holding of the magnet blocks 20 about the longitudinal axis A1, while limiting the risks of the arms 12 breaking.

As represented in FIG. 1, the circular ring 30 has a mainly annular shape. The circular ring 30 is disposed at the periphery of the rotor 1. The circular ring 30 surrounds the magnet blocks 20, and more specifically, the assembly formed by the body 10 and the magnet blocks 20. The circular ring 30 is in contact by its inner face 31 with the outer faces 23 of the magnet blocks 20.

The circular ring 30 is, in this case, made of aluminum. Aluminum is indeed cheaper than the carbon fiber materials conventionally used for circular rings. Using an aluminum circular ring 30 is in particular made possible as, as is described below, the implementation of the circular ring 30 does not require fretting.

In addition, it is, in this case, provided that the circular ring 30 is only in contact with the magnet blocks 20. This means that the circular ring 30 is not in contact with the body 10. For this, the magnet blocks 20 slightly project from the notches 13 at the periphery of the rotor 1. The whole urge exerted by the circular ring 30 is thus applied to the magnet blocks 20, which improves their holding in the notches 13.

In a variant, the circular ring 30 could come into contact with the magnet blocks 20 and with the body 10.

In this case, the circular ring 30 is resilient. This means, in this case, that the circular ring 30 can slightly be deformed when the rotor rotates, accelerates or decelerates suddenly.

Preferably, the circular ring 30 is profiled in this sense that it has a cross-section of invariable shape all along its contour. Its implementation on the magnet blocks 20 is thus facilitated.

The holding of the circular ring 30 on these magnet blocks is not done by a forceful mounting or via the use of adhesive or of mounted fixing means. On the contrary, it is done by engagement of geometric shapes.

In this case, the inner face 31 of the circular ring 30 or the outer faces 23 of the magnet blocks 20 have a first depression 50. The outer faces 23 of the magnet blocks 20, or respectively the inner face 31 of the circular ring 30, have a shape complementary to the first depression 50. Thus, the inner face 31 of the circular ring 30 or the outer faces 23 of the magnet blocks 20 are designed to be nested in one another at the first depression 50.

When the outer faces 23 of the magnet blocks 20 have a first depression 50, this thus means that each outer face 23 has a first depression 50, which is preferably identical on all the outer faces 23.

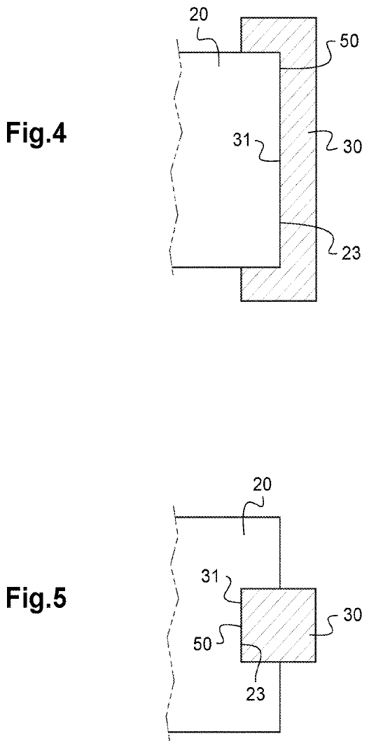

Generally, a complementary shape does not mean, in this case, that the face in question, i.e. that inner face 31 of the circular ring 30 or the outer face 23 of the magnet block 20, necessarily has a protrusion of shape complementary to the first depression 50, even if this can be the case. As appears in the examples illustrated in FIGS. 4 and 5, the face in question can have a straight rectilinear profile (without raised part) while being designed to be nested, by its dimensions, in the first depression 50.

In the example illustrated in FIG. 4, the first depression 50 is located at the inner face 31 of the circular ring 30 and the magnet block 20 has a complementarily-shaped raised part. This case is that of the rotor 1 represented in FIG. 1. In this case, the circular ring 30 comprises a recess, the concavity of which is oriented towards the magnet blocks 20, i.e. towards the longitudinal axis A1. In this case, the outer face 23 of the magnet block 20 is in contact with the bottom of the recess formed in the inner face 31 of the circular ring 30.

In the example illustrated in FIG. 5, the first depression 50 is located on the outer face 23 of the magnet block 20 and the circular ring 30 has a complementary shape. However, it can be provided that the circular ring 30 has a height about the longitudinal axis A1 greater than that of the first depression 50 (the size of the inner face 31 does not thus correspond to that of the first depression 50), and that the inner face 31 of the circular ring 30 has a complementarily-shaped rib projecting to the first depression 50 provided in the outer face 23 of the magnet block 20.

In a variant, the circular ring could comprise both a recess surrounding the outer face of the magnet block and a projecting rib designed to be nested in an indentation of the outer face of the magnet block. Such a variant corresponding to a combination of the two examples illustrated in FIGS. 4 and 5.

The holding means 40 make it possible, in engagement with the circular ring 30, to hold the magnet blocks 20 in the notches 13, i.e. to secure them to the body 10.

In this case, as FIG. 1 shows, each holding means 40 is associated with a respective magnet block 20. In other words, it is provided, in this case, with one holding means 40 per magnet block 20. The rotor 1 therefore comprises as many holding means 40 as magnet blocks. In a variant, several holding means could be provided per magnet block.

It is observed, in FIG. 7 or 8, that each holding means 40 is arranged between the body 10 and a magnet block 20. More specifically, each holding means 40 is, in this case, arranged between the hub 11, at the base of two adjacent arms 12, and the inner face 22 of the magnet block 20.

Each holding means 40 is arranged so as to urge the associated magnet block 20 against the circular ring 30. Thus, the holding means 40 makes it possible to hold the circular ring 30 and the magnet block 20 nested at the first depression 50.

In this case, if the radial symmetry plane of a magnet block 30 is considered (comprising the longitudinal axis A1), each holding means 40 is disposed so as to exert a force on this magnet block in a direction comprised in this radial symmetry plane and oriented towards the periphery of the rotor 1.

To generate these forces, the holding means 40 are, in this case, preferably pre-urged. This means that they have undergone, at the time of their mounting on the body 10, a resilient deformation due to a compression about a radial axis with respect to the longitudinal axis A1. The urges that they generate on the magnet blocks 20 therefore come from return forces. For more reliability, the holding means 40 are preferably made in one piece. The holding means 40 are, for example, made of metal.

Thanks to the resilience of the holding means 40 and of the circular ring 30, when the rotor 1 is in operation and that radial forces, directed towards the center or the periphery of the rotor 1, are exerted on the magnet blocks 20, the latter can make small movements, while being permanently held on either side. The engagement of the holding means 40 and of the circular ring 30 makes it possible to dampen these movements. This freedom of movement transferred to the magnet blocks 20 makes it possible to limit jolts in the acceleration phase and in the deceleration phase and thus to limit the risks of the magnet blocks 20 breaking.

In this case, the holding means 40 are removable. This means that the holding means 40 can be disconnected from the rotor 1, for example using a specific tool, while leaving the magnet blocks 20 in the notches 13. Removable holding means 40 offer numerous maintenance options, for example, by enabling a removal of the rotor 1 with a reuse of its elements.

Preferably, the inner face 22 of the magnet blocks 20 each comprise a reinforcement designed to receive an end of the holding means 40.

In this case, the holding means 40 are, for example, springs, typically helical springs, or clips or fretted pin gauges. Spring blades could also be used. Preferably, all the holding means 40 of the rotor 1 are of the same type.

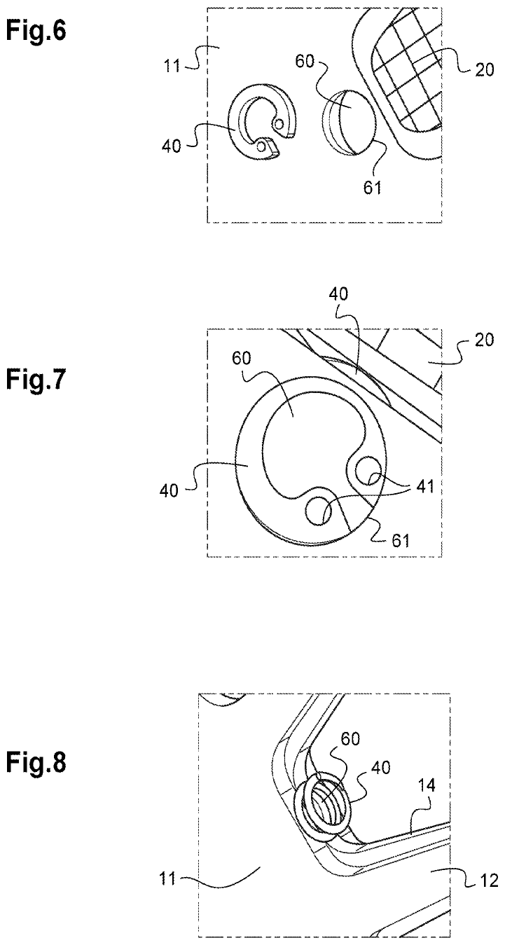

In a first embodiment of the rotor 1, shown in FIGS. 1, 6 and 7, the holding means 40 are clips. As represented in FIG. 6, the holding means 40 are more specifically circlips mainly having the shape of an open ring comprising, on either side of the opening, two orifices 41 designed to handle the holding means 40 using a specific tool (for example, circlip pliers). The resilient deformation of the holding means 40 is, in this case, a reduction of the diameter of the clips, i.e. a reduction of the opening of the ring.

In a second embodiment of the rotor 1, represented in FIG. 8, the holding means 40 are helical compression springs, the winding axis of the spirals of which corresponds to a radial direction. The resilient deformation of the holding means 40 is, in this case, a reduction of the length of the springs.

In a third embodiment (not represented), the holding means are fretted pin gauges. A pin gauge is, for example, a conic or truncated part forcefully arranged by its end having the smallest diameter between the body 10 and the magnet block 20. By inserting the pin gauge between the hub 11 and the inner face 23 of a magnet block 20, the magnet block 20 is progressively urged against the circular ring 30. The resilient deformation of the holding means 40 is, in this case, a slight compression of the volume of the pin gauge.

When the holding means are springs or clips (even pin gauges), the latter can be positioned in housings 60 provided in the body 10. A housing 60 is, in this case, a recessing, made in the body 10, the dimensions of which are adapted to receive at least one part of a holding means 40. The housings 60 are provided in the body 10 and more specifically, in the hub 11. The housings 60 open towards the magnet blocks 20, at an outlet oriented towards the periphery of the rotor 1, such that the holding means 40 can apply an urge on the magnet blocks 20.

In the first embodiment, as represented in FIGS. 6 and 7, the housing 60 is located in the hub 11 and has a disc shape centered on an axis parallel to the longitudinal axis A1.

In the first embodiment, shown in FIGS. 6 and 7, each housing 60 comprises, in addition to its outlet, an opening 61 specifically designed to introduce the holding means 40 in the housing 60. As FIGS. 6 and 7 show, the openings 61 are circular. The openings 61 are provided in the hub 11 at one of the two circular faces of the rotor 1. To prevent the holding means 40 from exiting the housing 60 unpredictably, the opening 61 has a size less than that of the holding means 40. In other words, the opening 61 has a size less than that of the housing 60 itself. In this case, the resilience of the holding means 40 is used to compress it and to introduce it through the opening 61. Once in the housing 60, the holding means 40 expand.

In the case of the second embodiment represented in FIG. 8, the housing 60 has the shape of a cylinder extending in a radial direction. The housing 60 is thus hollow in the outer face of the hub 11 which faces the associated magnet block. In a variant not represented, it can be provided that the housing 60 of the spring further comprises a rectangular-shaped opening enabling a side insertion of the spring when the latter is compressed.

In this case, the holding means 40 are eccentric with respect to the thickness of the body 10. In other words, the holding means 40 are not located at the middle of the thickness of the body 10, but are closer to one of the two circular faces of the rotor 1. This positioning of the holding means 40 can be particularly seen in FIG. 8. In this case, the housings 60 themselves are eccentric with respect to the thickness of the body 10. Due to this eccentricity, each holding means 40 applies a force on the associated magnet block 20, which improves the holding of the magnet block 20 in the notch 13.

Now, in reference to FIGS. 6 to 8, two embodiments of a method for assembling the rotor 1 are described.

In these two embodiments, the assembly method comprises the following main steps:
e1—insertion of the magnet blocks 20 between the arms 12 (an anti-vibration seal or a resilient strip, for example made of foam, being optionally adhered to the inner face 22 of the magnet blocks 20 before their insertion between the arms 12;
e2—implementation of the circular ring 30 around the magnet blocks 20;
e3—activation of the holding means 40 between the body 10 and the magnet blocks 20 so as to urge the magnet blocks 20 against the circular ring 30.

The first embodiment of the assembly method is illustrated in FIGS. 6 and 7. In this first embodiment, the circular ring 30 has a hollow recess in its inner face and the holding means 40 are clips.

This first embodiment is characterized by the fact that the holding means 40 are implemented after the implementation of the circular ring 30 around the magnet blocks 20.

During a preliminary step, the magnet blocks 20 are assembled by adhering or fretting the single magnets 25 in the peripheral support 26.

Then, during the insertion step e1, the magnet blocks 20 are inserted between the arms 12 of the body 10 in substantially radial directions. The insertion is guided by the slider connections between the arms 12 and the side faces 21 of the magnet blocks 20. The magnet blocks 20 are inserted until their inner faces 22 are in contact with the hub 11.

Thus, the following implementation step e2, the circular ring 30 can be implemented without forcing, typically without fretting. Indeed, the circular ring 30 is, in this case, slightly wider than the perimeter of the magnet blocks 20 when the latter are flattened against the hub 11 of the body 10. In this configuration, a clearance between the perimeter of the magnet blocks 20 and the circular ring 30 makes it possible to implement the latter easily. It is only during the step e3 of activating the holding means 40 that the magnet blocks 20 come back into contact with the circular ring 30.

The circular ring 30 is thus removable, in this case, in particular with respect to the body 10, in the sense where the latter is adapted to be reversibly mounted around the magnet blocks 20.

The activation step e3 comprises, in this case, the following substeps:
gripping and compression of the holding means 40 by a tool;
insertion of the holding means 40 in the housing 60 through the opening 61;
removal of the tool and deployment of the holding means 40, which leads to the urging of the magnet block 20 against the circular ring 30.

In this case, the tool is, for example, designed to grip a clip at the two orifices 41. By moving closer to these two orifices 41, the diameter of the clip decreases, which makes it possible to position it in the housing 60. By removing the tool, the clip expands and abuts against the inner face 23 of the magnet block 20.

During the activation step e3, the magnet blocks 20 are nested with the circular ring 30 at the depression 50, that this is provided on the circular ring 30 as in FIG. 5 or that this is provided on the outer faces 23 of the magnet blocks 20 as in FIG. 4.

In a variant, it can be provided that the holding means are fretted pin gauges and that the activation step consists of inserting the pin gauges between the body and the magnet blocks, for example by means of a press. Also, in a variant, it can be provided that the holding means are springs introduced laterally in the housings through the rectangular openings.

A second embodiment of the assembly method is illustrated by FIG. 8. In this second embodiment, the holding means 40 are springs. This second embodiment is distinguished from the first embodiment, in that the holding means 40 are positioned in the housings 60 before the implementation of the magnet blocks 20.

Thus, before the step e1 of inserting the magnet blocks 20, the assembly method according to this second embodiment comprises a preliminary step of placing the holding means 40 on the body 10.

Once inserted between the arms of the body 10, the magnet blocks 20 are compressed against the hub 11 (the springs are therefore also compressed). This makes it possible, as in the first embodiment, to implement the circular ring 30 without forcing, thanks to a clearance between the perimeter of the magnet blocks 20 and the circular ring 30.

The step e3 of activating the holding means 40 thus consists of relaxing the compression of the magnet blocks 20 such that the holding means 40 can expand.

Now, a method for removing the rotor 1 is described, comprising the following main steps:
e4—deactivation of the holding means 40 so as to separate the magnet blocks 20 from the circular ring 30;
e5—removal of the circular ring 30 from the periphery of the magnet blocks 20;
e6—removal of at least one of the magnet blocks 20 from between the arms 12.

When the rotor 1 has been assembled according to the first embodiment, the deactivation step e4 comprises the following substeps:
gripping and compression of the clip by a tool, which leads to the de-urging of the magnet block 20;
removal of the holding means 40 from the housing 60 through the opening 61.

The magnet blocks 20 can then be moved closer to the body 10, typically until putting the inner face 23 in contact with the hub 11, to produce the clearance between the perimeter of the magnet blocks 20 and the circular ring 30. During the step e5 of removing the circular ring 30, the latter can thus be removed without difficulty.

When the rotor 1 has been assembled according to the second embodiment, the deactivation step e4 comprises the compression of the magnet blocks 20, and therefore the holding means 40, against the body 10 towards the longitudinal axis A1 to produce the clearance mentioned above.

Then, during the following removal step e6, one, more or all the magnet blocks 20 can be removed.

This removal method has numerous advantages, such as being able to replace or repair an element of the rotor 1 or being able to separate and sort the different elements with a view to recycling them.

The present invention is not at all limited to the embodiments described and represented, but a person skilled in the art will know how to provide any variant according to the invention.

1. Rotor for an axial flux electric machine, said rotor having a disc shape centred about a longitudinal axis and comprising:
a body comprising a hub from which a plurality of arms extend;
a plurality of magnet blocks, each magnet block being disposed between two adjacent arms;
a circular ring disposed at the periphery of the rotor and surrounding the magnet blocks,
wherein:
one of an inner face of the circular ring and an outer face of each of the magnet blocks has a first depression, the other having a complementary shape;
the rotor comprises a plurality of holding means, each arranged between the body and a magnet block so as to urge said magnet block against the circular ring, with the circular ring and said magnet block nested at said first depression.

2. The rotor according to claim 1, wherein said holding means are removable.

3. Rotor according to claim 1, wherein each of said holding means is disposed in a housing provided in the body, said housing comprising an opening designed to introduce said holding means in said housing, said opening having a size less than that of said holding means.

4. The rotor according to claim 1, wherein said holding means are springs or clips or fretted pin gauges.

5. The rotor according to claim 1, wherein each of said holding means is surrounded between an inner face of a magnet block and the body.

6. The rotor according to claim 1, wherein each of said holding means is eccentric with respect to the thickness of the body about the longitudinal axis.

7. The rotor according to claim 1, wherein each of said arms comprises two second depressions or protrusions opposite one another and extending in length in an extension direction of said arm, and wherein each of said magnet blocks has two side faces, each comprising a third depression or protrusion of shape complementary to that of the second depression or protrusion of the arm with which said side face is in contact.

8. The rotor according to claim 7, wherein each of said second depressions or protrusions has a depth or respectively a height increasing by moving closer to the longitudinal axis.

9. The rotor according to claim 1, wherein each of said magnet blocks comprises a plurality of single magnets glued or fretted in a peripheral support.

10. The rotor according to claim 1, wherein anti-vibration means are provided between each magnet block and the hub.

11. Method for assembling a rotor according to claim 1, the method comprising:
inserting the magnet blocks between the arms;
implementing the circular ring around the magnet blocks;
activating the holding means between the body and the magnet blocks so as to urge the magnet blocks against the circular ring.

12. Method for removing the rotor according to claim 1, the method comprising:
deactivating the holding means so as to separate the magnet blocks from the circular ring;
removing the circular ring from the periphery of the magnet blocks;
removing at least one of the magnet blocks from between the arms.
